(19) United States
(12) Patent Application Publication
(10) Pub. No.: US 2018/0349443 A1
(43) Pub. Date: Dec. 6, 2018

(54) EDGE STORE COMPRESSION IN GRAPH DATABASES

(71) Applicant: LinkedIn Corporation, Sunnyvale, CA (US)

(72) Inventors: Andrew J. Carter, Mountain View, CA (US); Andrew Rodriguez, Palo Alto, CA (US); Srinath Shankar, Mountain View, CA (US); Scott M. Meyer, Berkeley, CA (US)

(73) Assignee: LinkedIn Corporation, Sunnyvale, CA (US)

(21) Appl. No.: 15/609,250

(22) Filed: May 31, 2017

(51) Int. Cl. G06F 17/30

(52) U.S. Cl. CPC G06F 17/30501; G06F 17/30424; G06F 17/30277

(57) ABSTRACT

The disclosed embodiments provide a system for processing and storing data. During operation, the system obtains a set of records sorted by a first integer value, with each record containing the first integer value and one or more additional integer values. The system sets, for each integer value in each record, a delta encoding bit that indicates whether the integer value is delta encoded with respect to at least one other integer value in the records. Next, the system uses a delta encoding state represented by the delta encoding bit to calculate an encoded value from the integer value. The system then encodes a length of the encoded value in a length tag for the integer value and replaces the integer value in the record with an encoded version containing the delta encoding bit, the length tag, and the encoded value.

### RELATED APPLICATIONS

The subject matter of this application is related to the subject matter in a co-pending non-provisional application by inventors Srinath Shankar, Robert W. Stephenson, Andrew J. Carter, Maverick Shu-Bun Lee and Scott M. Meyer, entitled “Graph-Based Queries,” having Ser. No. 14/858,178, and filing date Sep. 18, 2015 (Attorney Docket No. LI-P1664.LNK.US).

The subject matter of this application is also related to the subject matter in a co-pending non-provisional application by inventors SungJu Cho, Yinyi Wang, Qingpeng Niu and Andrew Rodriguez, entitled “Encoding Edges in Graph Databases,” having Ser. No. 15/337,716 and filing date 28 Oct. 2016 (Attorney Docket No. LI-P2080.LNK.US).

The subject matter of this application is also related to the subject matter in a co-pending non-provisional application by inventors Andrew Rodriguez, Andrew J. Carter, Scott M. Meyer and Srinath Shankar, entitled “Edge Store Designs for Graph Databases,” having Ser. No. 15/360,605, and filing date 23 Nov. 2016 (Attorney Docket No. LI-P2152.LNK.US).

### BACKGROUND

### Field

The disclosed embodiments relate to graph databases. More specifically, the disclosed embodiments relate to techniques for performing edge store compression in graph databases.

### Related Art

Data associated with applications is often organized and stored in databases. For example, in a relational database data is organized based on a relational model into one or more tables of rows and columns, in which the rows represent instances of types of data entities and the columns represent associated values. Information can be extracted from a relational database using queries expressed in a Structured Query Language (SQL).

In principle, by linking or associating the rows in different tables, complicated relationships can be represented in a relational database. In practice, extracting such complicated relationships usually entails performing a set of queries and then determining the intersection of or joining the results. In general, by leveraging knowledge of the underlying relational model, the set of queries can be identified and then performed in an optimal manner.

However, applications often do not know the relational model in a relational database. Instead, from an application perspective, data is usually viewed as a hierarchy of objects in memory with associated pointers. Consequently, many applications generate queries in a piecemeal manner, which can make it difficult to identify or perform a set of queries on a relational database in an optimal manner. This can degrade performance and the user experience when using applications.

Various approaches have been used in an attempt to address this problem, including using an object-relational mapper, so that an application effectively has an understanding or knowledge about the relational model in a relational database. However, it is often difficult to generate and to maintain the object-relational mapper, especially for large, real-time applications.

Alternatively, a key-value store (such as a NoSQL database) may be used instead of a relational database. A key-value store may include a collection of objects or records and associated fields with values of the records. Data in a key-value store may be stored or retrieved using a key that uniquely identifies a record. By avoiding the use of a predefined relational model, a key-value store may allow applications to access data as objects in memory with associated pointers (i.e., in a manner consistent with the application's perspective). However, the absence of a relational model means that it can be difficult to optimize a key-value store. Consequently, it can also be difficult to extract complicated relationships from a key-value store (e.g., it may require multiple queries), which can also degrade performance and the user experience when using applications.

### BRIEF DESCRIPTION OF THE FIGURES

FIG. 1 shows a schematic of a system in accordance with the disclosed embodiments.

FIG. 2 shows a graph in a graph database in accordance with the disclosed embodiments.

FIG. 3 shows a system for improving the memory footprint of a graph database in accordance with the disclosed embodiments.

FIG. 4 shows an exemplary encoding of records in a graph database in accordance with the disclosed embodiments.

FIG. 5 shows a flowchart illustrating the processing of data in accordance with the disclosed embodiments.

FIG. 6 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

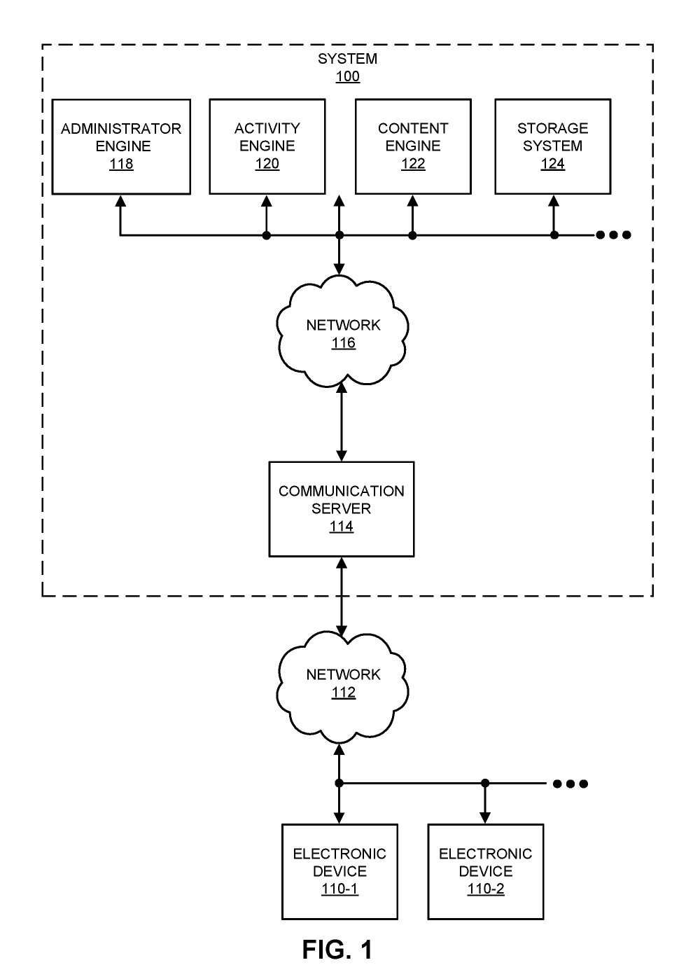

The disclosed embodiments provide a method, apparatus and system for storing and processing data in a graph database. A system 100 for performing a technique described herein is shown in FIG. 1. In this system, users of electronic devices 110 may use a service that is, at least in part, provided using one or more software products or applications executing in system 100. As described further below, the applications may be executed by engines in system 100.

Moreover, the service may, at least in part, be provided using instances of a software application that is resident on and that executes on electronic devices 110. In some implementations, the users may interact with a web page that is provided by communication server 114 via network 112, and which is rendered by web browsers on electronic devices 110. For example, at least a portion of the software application executing on electronic devices 110 may be an application tool that is embedded in the web page, and that executes in a virtual environment of the web browsers. Thus, the application tool may be provided to the users via a client-server architecture.

The software application operated by the users may be a standalone application or a portion of another application that is resident on and that executes on electronic devices 110 (such as a software application that is provided by communication server 114 or that is installed on and that executes on electronic devices 110).

A wide variety of services may be provided using system 100. In the discussion that follows, a social network (and, more generally, a network of users), such as an online professional network, which facilitates interactions among the users, is used as an illustrative example. Moreover, using one of electronic devices 110 (such as electronic device 110-1) as an illustrative example, a user of an electronic device may use the software application and one or more of the applications executed by engines in system 100 to interact with other users in the social network. For example, administrator engine 118 may handle user accounts and user profiles, activity engine 120 may track and aggregate user behaviors over time in the social network, content engine 122 may receive user-provided content (audio, video, text, graphics, multimedia content, verbal, written, and/or recorded information) and may provide documents (such as presentations, spreadsheets, word-processing documents, web pages, etc.) to users, and storage system 124 may maintain data structures in a computer-readable memory that may encompass multiple devices, i.e., a large-scale distributed storage system.

Note that each of the users of the social network may have an associated user profile that includes personal and professional characteristics and experiences, which are sometimes collectively referred to as ‘attributes’ or ‘characteristics.’ For example, a user profile may include demographic information (such as age and gender), geographic location, work industry for a current employer, an employment start date, an optional employment end date, a functional area (e.g., engineering, sales, consulting), seniority in an organization, employer size, education (such as schools attended and degrees earned), employment history (such as previous employers and the current employer), professional development, interest segments, groups that the user is affiliated with or that the user tracks or follows, a job title, additional professional attributes (such as skills), and/or inferred attributes (which may include or be based on user behaviors).

Moreover, user behaviors may include log-in frequencies, search frequencies, search topics, browsing certain web pages, locations (such as IP addresses) associated with the users, advertising or recommendations presented to the users, user responses to the advertising or recommendations, likes or shares exchanged by the users, interest segments for the likes or shares, and/or a history of user activities when using the social network. Furthermore, the interactions among the users may help define a social graph in which nodes correspond to the users and edges between the nodes correspond to the users' interactions, interrelationships, and/or connections. However, as described further below, the nodes in the graph stored in the graph database may correspond to additional or different information than the members of the social network (such as users, companies, etc.). For example, the nodes may correspond to attributes, properties or characteristics of the users.

As noted previously, it may be difficult for the applications to store and retrieve data in existing databases in storage system 124 because the applications may not have access to the relational model associated with a particular relational database (which is sometimes referred to as an ‘object-relational impedance mismatch’). Moreover, if the applications treat a relational database or key-value store as a hierarchy of objects in memory with associated pointers, queries executed against the existing databases may not be performed in an optimal manner. For example, when an application requests data associated with a complicated relationship (which may involve two or more edges in a graph database, and which is sometimes referred to as a ‘compound relationship’), a set of queries may be performed and then the results may be linked or joined. To illustrate this problem, rendering a web page for a blog may involve a first query for the three-most-recent blog posts, a second query for any associated comments, and a third query for information regarding the authors of the comments. Because the set of queries may be suboptimal, obtaining the results may be time-consuming. This degraded performance may, in turn, degrade the user experience when using the applications and/or the social network.

In order to address these problems, storage system 124 may include a graph database that stores a graph (e.g., as part of an information-storage-and-retrieval system or engine). Note that the graph may allow an arbitrarily accurate data model to be obtained for data that involves fast joining (such as for a complicated relationship with skew or large ‘fan-out’ in storage system 124), which approximates the speed of a pointer to a memory location (and thus may be well suited to the approach used by applications).

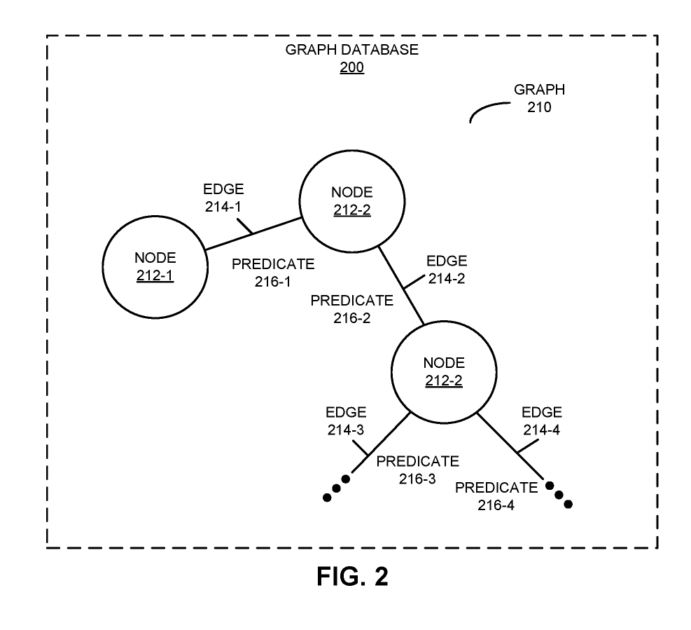

FIG. 2 presents a block diagram illustrating a graph 210 stored in a graph database 200 in system 100 (FIG. 1). Graph 210 includes nodes 212, edges 214 between nodes 212, and predicates 216 (which are primary keys that specify or label edges 214) to represent and store the data with index-free adjacency, i.e., so that each node 212 in graph 210 includes a direct edge to its adjacent nodes without using an index lookup.

Each edge in graph 210 may be specified in a (subject, predicate, object) triple. For example, an edge denoting a connection between two members named “Alice” and “Bob” may be specified using the following statement:

Edge(“Alice”, “ConnectedTo”, “Bob”)

In the above statement, “Alice” is the subject, “Bob” is the object, and “ConnectedTo” is the predicate.

In addition, specific types of edges and/or more complex structures in graph 210 may be defined using schemas. Continuing with the previous example, a schema for employment of a member at a position within a company may be defined using the following:

DefPred(“Position/company”, “1”, “node”, “0”, “node”).
DefPred(“Position/member”, “1”, “node”, “0”, “node”).
DefPred(“Position/start”, “1”, “node”, “0”, “date”).
DefPred(“Position/end_date”, “1”, “node”, “0”,

“date”).

M2C(positionId, memberId, companyId, start, end) :-

Edge(positionId, “Position/member”, memberId),
Edge(positionId, “Position/company”, companyId),
Edge(positionId, “Position/start”, start),
Edge(positionId, “Position/end_date”, end)

In the above schema, the employment is represented by four predicates, followed by a rule with four edges that use the predicates. The predicates include a first predicate representing the position at the company (e.g., “Position/company”), a second predicate representing the position of the member (e.g., “Position/member”), a third predicate representing a start date at the position (e.g., “Position/start”), and a fourth predicate representing an end date at the position (e.g., “Position/end_date”). In the rule, the first edge uses the second predicate to specify a position represented by “positionId” held by a member represented by “memberId,” and the second edge uses the first predicate to link the position to a company represented by “companyId.” The third edge of the rule uses the third predicate to specify a “start” date of the member at the position, and the fourth edge of the rule uses the fourth predicate to specify an “end” date of the member at the position.

Graph 210 and the associated schemas may additionally be used to populate graph database 200 for processing of queries against the graph. More specifically, a representation of nodes 212, edges 214, and predicates 216 may be obtained from a source of truth, such as a relational database, distributed filesystem, and/or other storage mechanism, and stored in a log in the graph database. Lock-free access to the graph database may be implemented by appending changes to graph 210 to the end of the log instead of requiring modification of existing records in the source of truth. In turn, the graph database may provide an in-memory cache of the log and an index for efficient and/or flexible querying of the graph.

In other words, nodes 212, edges 214, and predicates 216 may be stored as offsets in a log that is read into memory in graph database 200. For example, the exemplary edge statement for creating a connection between two members named “Alice” and “Bob” may be stored in a binary log using the following format:

| | |
|---|---|
| 256 | Alice |
| 261 | Bob |
| 264 | ConnectedTo |
| 275 | (256, 264, 261) |

In the above format, each entry in the log is prefaced by a numeric (e.g., integer) offset representing the number of bytes separating the entry from the beginning of the log. The first entry of “Alice” has an offset of 256, the second entry of “Bob” has an offset of 261, and the third entry of “ConnectedTo” has an offset of 264. The fourth entry has an offset of 275 and stores the connection between “Alice” and “Bob” as the offsets of the previous three entries in the order in which the corresponding fields are specified in the statement used to create the connection (i.e., Edge(“Alice”, “ConnectedTo”, “Bob”)).

Because the ordering of changes to graph 210 is preserved in the log, offsets in the log may be used as identifiers for the changes. Continuing with the previous example, the offset of 275 may be used as a unique identifier for the edge representing the connection between “Alice” and “Bob.” The offsets may additionally be used as representations of virtual time in the graph. More specifically, each offset in the log may represent a different virtual time in the graph, and changes in the log up to the offset may be used to establish a state of the graph at the virtual time. For example, the sequence of changes from the beginning of the log up to a given offset that is greater than 0 may be applied, in the order in which the changes were written, to construct a representation of the graph at the virtual time represented by the offset.

Note that graph database 200 may be an implementation of a relational model with constant-time navigation, i.e., independent of the size N, as opposed to varying as log(N). Furthermore, a schema change in graph database 200 (such as the equivalent to adding or deleting a column in a relational database) may be performed with constant time (in a relational database, changing the schema can be problematic because it is often embedded in associated applications). Additionally, for graph database 200, the result of a query may be a subset of graph 210 that maintains the structure (i.e., nodes, edges) of the subset of graph 210.

A graph-storage technique described herein may include embodiments of methods that allow the data associated with the applications and/or the social network to be efficiently stored and retrieved from graph database 200. Such methods are described in a co-pending non-provisional application by inventors Srinath Shankar, Rob Stephenson, Andrew Carter, Maverick Lee and Scott Meyer, entitled “Graph-Based Queries,” having Ser. No. 14/858,178, and filing date Sep. 18, 2015 (Attorney Docket No. LI-P1664.LNK.US), which is incorporated herein by reference.

Referring back to FIG. 1, the graph-storage techniques described herein may allow system 100 to efficiently and quickly (e.g., optimally) store and retrieve data associated with the applications and the social network without requiring the applications to have knowledge of a relational model implemented in graph database 200. For example, graph database 200 may be configured to store data associated with a variety of flexible schemas using edges representing subjects, objects, and predicates in the graph. Consequently, the graph-storage techniques may improve the availability and the performance or functioning of the applications, the social network and system 100, which may reduce user frustration and which may improve the user experience. Therefore, the graph-storage techniques may increase engagement with or use of the social network, and thus may increase the revenue of a provider of the social network.

Note that information in system 100 may be stored at one or more locations (i.e., locally and/or remotely). Moreover, because this data may be sensitive in nature, it may be encrypted. For example, stored data and/or data communicated via networks 112 and/or 116 may be encrypted.

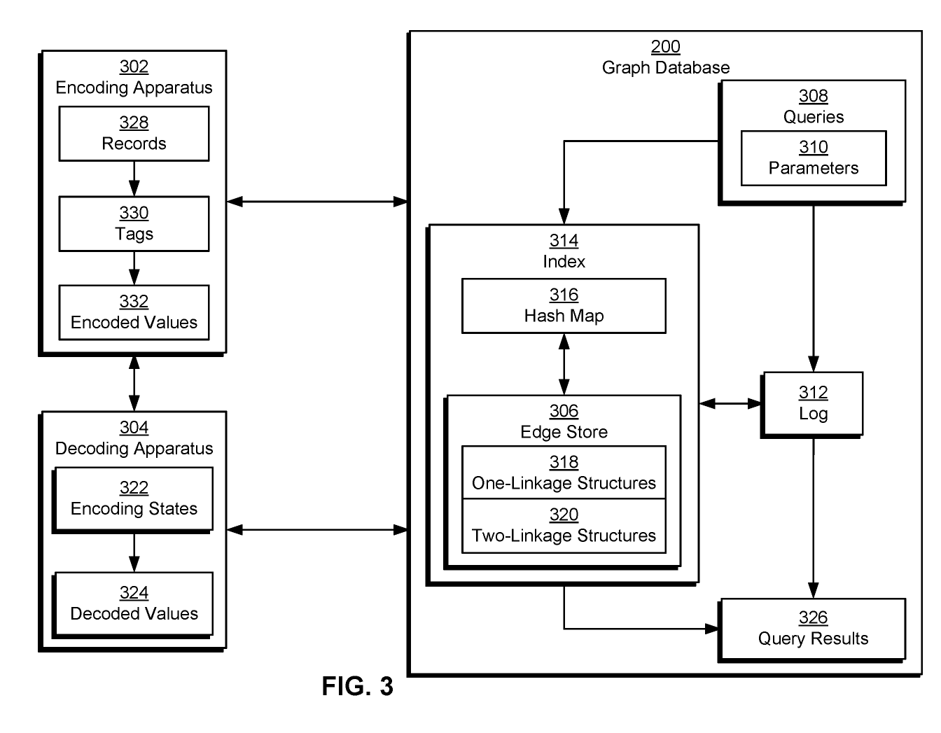

Graph database 200 may also include an in-memory index structure that enables efficient lookup of edges 214 of graph 210 by subject, predicate, object, and/or other keys or parameters. As shown in FIG. 3, an index 314 for graph database 200 may include a hash map 316 and an edge store 306. Index 314 may be generated from and/or used with a log 312 in graph database 200. Hash map 316 and edge store 306 may be accessed simultaneously by a number of processes, including a single write process and multiple read processes. In turn, the processes may read from index 314, write to index 314, and/or process deleted edges using index 314.

Hash map 316 may include a set of fixed-size hash buckets, each of which contains a set of fixed-size entries. Each entry in hash map 316 may include one or more keys and one or more values associated with the key(s). The keys may include attributes by which the graph database is indexed, and the values may represent attributes in the graph database that are associated with the keys. For example, the keys may be subjects, predicates, and/or objects that partially define edges in the graph, and the values may include offsets into edge store 306 that are used to resolve the edges.

A hash bucket may also include a reference to an overflow bucket containing additional hash table entries with the same hash as the hash bucket. While the hash bucket has remaining capacity, the hash bucket may omit a reference to any overflow buckets. When the remaining capacity of the hash bucket is consumed by entries in the hash bucket, an overflow bucket is instantiated in the hash table, additional entries are stored in the overflow bucket, and a reference to the overflow table is stored in a header and/or an entry in the hash bucket.

When a query of graph database 200 is received, a key and/or other parameter (e.g., parameters 310) in the query may be matched to an entry in hash map 316, and an offset in the entry is used to retrieve the corresponding edges from edge store 306. For example, the key may include a subject, predicate, object, and/or other attribute associated with the edges. A hash of the key may be used to identify a hash bucket in hash map 316, and another hash of the key may be used to identify the corresponding entry in the hash bucket. Because the hash buckets and entries are of fixed size, a single calculation (e.g., a first hash of the key modulo the number of hash buckets +a second hash of the key modulo the number of entries in each hash bucket) may be used to identify the offset or address of the corresponding entry in the hash map. In turn, the same entry may be reused to store a different fixed-size value instead of requiring the creation of another entry in the hash bucket to store the fixed-size value.

An offset into edge store 306 may be obtained from the entry and used to retrieve and/or modify a set of edges matching the query from the edge store. Edge store 306 may include one-linkage structures 318 and two-linkage structures 320. Each one-linkage structure may specify one linkage (e.g., subject, predicate, or object) of a corresponding edge in edge store 306, and each two-linkage structure may specify two linkages of the corresponding edge in edge store 306. In other words, a linkage may be a subject, predicate, object, and/or other single attribute of an edge in the graph database.

Records in edge store 306 may also include an add/delete indication that identifies the record as an addition of the corresponding edge to the graph database or a deletion of the corresponding edge from the graph database. The records may be ordered to enable traversal of edge store 306 in decreasing order of edge ID, thereby allowing a set of deleted edges to be generated and compared with added edges so that only edges that have not been deleted are materialized in an edge set associated with edge store 306. Using edge stores to store and process added and deleted edges in graph databases is described in a co-pending non-provisional application by inventors Andrew Rodriguez, Andrew Carter, Scott Meyer and Srinath Shankar, entitled “Edge Store Designs for Graph Databases,” having Ser. No. 15/360,605, and filing date 23 Nov. 2016 (Attorney Docket No. LI-P2152.LNK.US), which is incorporated herein by reference.

In one or more embodiments, the system of FIG. 3 includes functionality to reduce the memory footprint (e.g., memory usage) of graph database 200 by encoding integer values in edge store 306 and/or other components of index 314 and/or log 312. More specifically, an encoding apparatus 302 may obtain records 328 from index 314 and/or log 312 containing groups of integers that specify numeric values, memory addresses, and/or offsets related to edges and/or other data structures in log 312 and/or index 314. For example, encoding apparatus 302 may obtain, from one-linkage structures 318 and/or two-linkage structures 320 in edge store 306, a number of records 328 for resolving edges in graph database 200. Each record may include a numeric identifier (ID) for an edge, such as an offset and/or 64-bit memory address in log 312 at which the edge is written. The record may also include additional linkages that are used to resolve the edge. For example, the record may include numeric values of a predicate, object, and/or other attributes of an edge with a subject that is shared with other records in the same two-linkage structure. In turn, the subject may be used as a key to retrieve an entry in hash map 316 containing an offset to the two-linkage structure in edge store 306.

Consequently, each record in edge store 306 and/or another component of graph database 200 may include a first integer value specifying an ID for an edge, one or more additional integer values identifying linkages and/or offsets used to resolve the edge, and one or more indications (e.g., bits, flags, etc.) of additions, deletions, and/or other write operations associated with the edge. Moreover, records 328 may be written to edge store 306 in an append-only fashion to allow traversal of edge IDs in the records in decreasing order during processing of deleted edges in graph database 200, as discussed in the above-referenced application.

To reduce the amount of memory required to store records 328 in edge store 306 and/or other parts of graph database 200, encoding apparatus 302 may apply a group varint encoding to each group of integer values in a record to generate encoded values 332 from the integer values. For example, encoding apparatus 302 may set a 3-bit length tag to represent, from 1 to 7, the number of bytes occupied by a corresponding encoded integer value in the record.

To further reduce the size of the encoded integer values in a given record, encoding apparatus 302 may selectively apply delta encoding to the integer values. As described above and in the above-reference application, records 328 in edge store 306 may be stored for traversal in decreasing order of edge ID. As a result, an encoded value for each edge ID may be calculated from the difference between the edge ID and a higher edge ID from an adjacent (e.g., newer) record in edge store 306. Moreover, each record may include one or more linkage values that are lower than the edge ID because the corresponding linkages are defined at log 312 offsets that are lower than the offset in log 312 at which the edge is written. Thus, an encoded value for each linkage value may optionally be calculated from the difference between the edge ID and the linkage value. In turn, encoding apparatus 302 may include, in tags 330, delta encoding tags that represent the delta encoding states of the corresponding integer values in each record. For example, each delta encoding tag may include a bit that indicates if delta encoding is applied to the corresponding integer value.

Encoding apparatus 302 may also use tags 330 to specify one or more write operations associated with each record. For example, encoding apparatus 302 may include, in tags 330, one or more bits that identify the record as an addition and/or a deletion of the corresponding edge in graph database 200.

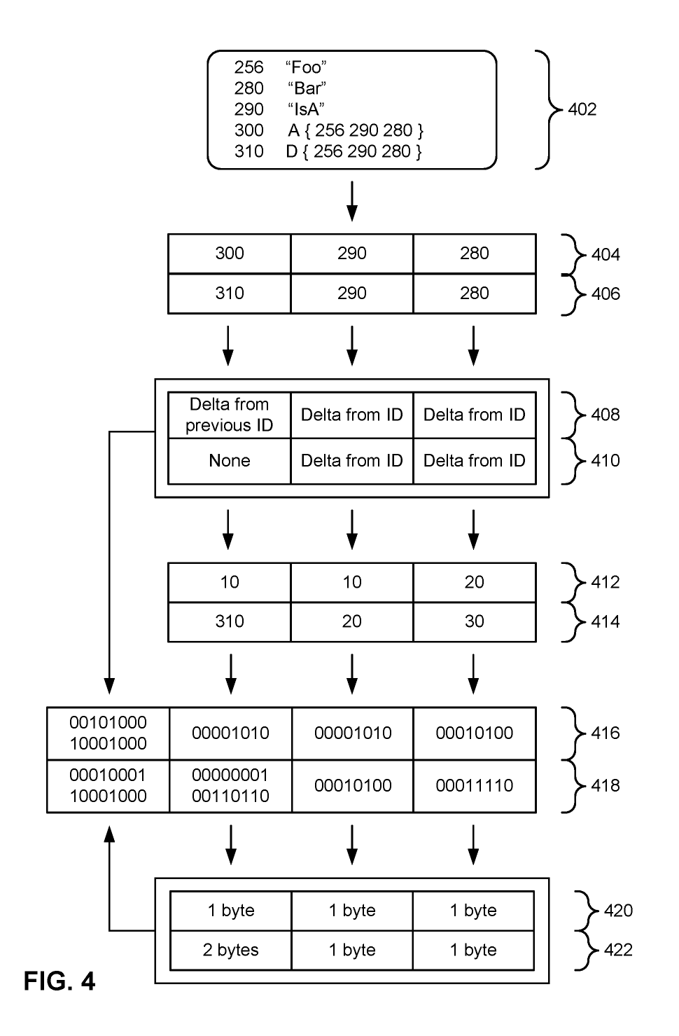

After tags 330 and encoded values 332 are generated for integer values in a set of records 328, encoding apparatus 302 may replace records 328 in graph database 200 with an encoded version of records 328, which includes tags 330 and encoded values 332. For example, the encoding apparatus may substitute integer values in keys, edges, offsets, records, and/or other data structures in log 312 and/or index 314 with the corresponding encoded versions to reduce the amount of memory and/or space required to store the integer groups. Encoding of integer groups in graph databases is described in further detail below with respect to FIG. 4.

In turn, a decoding apparatus 304 may use encoding states 322 represented by tags 330 stored with encoded values 332 to generate decoded values 324 for the corresponding records 328. Such decoding may be performed during processing of queries 308 of graph database 200 and/or analysis (e.g., testing, verification, etc.) of records 328 in graph database 200. To perform decoding of encoded values 332, decoding apparatus 304 may first use length information from the length tags to identify bytes containing the corresponding encoded integer values in a given record. Next, the decoding apparatus may perform a group varint decoding of the encoded integer values to obtain decoded integer values, which may include delta-encoded values. Decoding apparatus 304 may then use the decoded integer values and delta encoding states in the corresponding delta encoding tags to recover the original integer values from any delta-encoded values. After the original integer values are produced, decoding apparatus 304 may provide the integer values to graph database 200, and graph database 200 may include the integer values in query results 326 for one or more queries 308. By combining group varint and delta encodings with integer values that are ordered and/or structured in pre-specified ways within graph database 200, encoding apparatus 302 and decoding apparatus 304 may reduce the memory footprint of graph database 200 without incurring excessive decoding overhead during processing of queries 308.

Those skilled in the art will appreciate that the system of FIG. 3 may be implemented in a variety of ways. First, encoding apparatus 302, decoding apparatus 304, and/or graph database 200 may be provided by a single physical machine, multiple computer systems, one or more virtual machines, a grid, one or more databases, one or more filesystems, and/or a cloud computing system. Encoding apparatus 302, decoding apparatus 304, and graph database 200 may additionally be implemented together and/or separately by one or more hardware and/or software components and/or layers. For example, encoding apparatus 302 and/or decoding apparatus 304 may be included in query-processing components of graph database 200 or execute separately from the query-processing components and/or graph database 200.

Second, encoding and decoding of records 328 in graph database 200 may be performed at various times. For example, encoding apparatus 302 may generate tags 330 and encoded values 332 for integer values in records 328 as records 328 are written to graph database 200, upon batch loading of records 328 into the graph database, and/or during batch conversion of records 328 to encoded versions of records 328 within graph database 200. Similarly, decoding apparatus 304 may generate decoded values 324 during matching of parameters 310 (e.g., subjects, predicates, objects, offsets, keys, etc.) of queries 308 to records 328 in log 312 and/or index 314 and inclusion of records 328 in query results 326 that are returned in response to queries 308.

FIG. 4 shows an exemplary encoding of records in a graph database, such as graph database 200 of FIG. 2, in accordance with the disclosed embodiments. For example, the exemplary encoding of FIG. 4 may be performed by encoding apparatus 302 of FIG. 3. As shown in FIG. 4, the graph database may include a log 402 with a series of entries. The first entry of “Foo” has an offset of 256, the second entry of “Bar” has an offset of 280, and the third entry of “IsA” has an offset of 290. The fourth entry has an offset of 300 and stores the “IsA” relationship between “Foo” and “Bar” as the offsets of the previous three entries in the order in which the corresponding fields are specified in the statement used to create the connection (i.e., Edge(“Foo”, “IsA”, “Bar”)). The fourth entry additionally includes an addition flag (e.g., “A”) indicating an addition of the edge to the graph database. On the other hand, the fifth entry has an offset of 310 and a deletion flag (e.g., “D”) indicating a deletion of the same edge from the graph database.

The fourth and fifth entries in log 402 may be represented using two records 404-406 in an edge store for the graph database. The edge store may include an edge ID corresponding to the integer offset of each entry (e.g., 310 and 300), followed by two additional integers corresponding to linkage values that represent the predicate (e.g., 290) and object (e.g., 280) defining the edge. Thus, records 404-406 may be found in a two-linkage structure in the edge store that is referenced by the corresponding subject value (e.g., 256) from a hash map in an index for the graph database.

To reduce the amount of memory required to store the graph database, records 404-406 may be converted into encoded versions 416-418 of records 404-406. First, a set of delta encoding states 408-410 is determined for integer values in records 404-406 and used to generate a set of deltas 412-414 from the integer values. Delta encoding states 408-410 may indicate if the deltas are to be calculated for integer values in the corresponding records 404-406. Because records 404-406 are sorted by edge ID (e.g., the first integer value in each record), each edge ID may be delta encoded using an adjacent edge ID from a newer edge. Similarly, linkage values following the edge ID in each record may have deltas that are calculated from the edge ID because the linkage values are always lower than the edge ID.

In one or more embodiments, delta encoding of integer values in the edge store is performed in the reverse order from which the corresponding records 404-406 are added to a given structure (e.g., one-linkage structure or two-linkage structure) in the edge store. Such delta encoding may allow the encoded values to be decoded during traversal of the edge store in the same reverse order (e.g., to process deleted edges in the graph database). Thus, delta encoding states 410 for integer values in record 406 may be determined before delta encoding states 408 for integer values in record 404. Delta encoding states 410 specify that the edge ID in record 406 lacks delta encoding (e.g., “None”) because record 406 has the highest edge ID in the edge store. Delta encoding states 410 may also be set to specify delta encoding of the two linkage values in record 406 from the record's edge ID (e.g., “Delta from ID”) because deltas 414 between the linkage values and the edge ID (i.e., 20 and 30) occupy fewer bytes than the non-delta-encoded linkage values (i.e., 290 and 280).

After delta encoding states 410 are determined for integer values in record 406, delta encoding states 408 may be selected for integer values in record 404. Delta encoding states 408 specify delta encoding of the edge ID in record 404 using the edge ID in record 406 (e.g., “Delta from previous ID”) because the difference between the two edge IDs (i.e., 10) occupies the same number of bytes or fewer bytes than the non-delta-encoded edge ID in record 404 (i.e., 300). Delta encoding states 408 may also specify delta encoding of the two linkage values in record 404 from the record's edge ID (e.g., “Delta from ID”) because deltas 412 between the linkage values and the edge ID (i.e., 10 and 20) occupy the same number of bytes or fewer bytes than the non-delta-encoded linkage values (i.e., 290 and 280). In general, if the non-delta-encoded and delta-encoded integer values occupy the same number of bytes, delta encoding of the integer values may be performed or omitted for efficiency and other reasons.

Delta encoding states 408-410 may be used to produce deltas 412-414 from integer values in the corresponding records 408-410, which are then converted using a group varint encoding to produce encoded versions 416-418 of records 404-406. Encoded version 416 may include the same encoded binary value of “00001010” for the delta-encoded value of 10 for the edge ID and the first linkage in record 404 and a different encoded binary value of “00010100” for the delta-encoded value of 20 for the second linkage value in record 404. Encoded version 418 may include an encoded binary value of “00000001 00110110” for the non-delta-encoded edge ID of 310 for record 406, an encoded binary value of “00010100” for the delta-encoded value of 20 for the first linkage in record 406, and an encoded binary value of “00011110” for the delta-encoded value of 30 for the second linkage in record 406.

Lengths 420-422 of the encoded values may also be calculated as one byte for each encoded integer value in encoded version 416 of record 404, two bytes for the encoded edge ID in encoded version 418 of record 406, and one byte for each linkage value in encoded version 418 of record 406. Lengths 420-422 and delta encoding states 408-410 may then be included with additional information in two additional bytes of each encoded version.

In particular, each record may be encoded using the following exemplary representation:

Entry {

EdgeInfo {

_unused_ (2)
WriteOp (1)
Deleted (1)
IdDeltaCompressed (1)
IdVBESize (3)

}
LinkInfo {

Link1IsDeltaCompressed (1)
Link1VBESize (3)
Link2IsDeltaCompressed (1)
Link2VBESize (3)

}
Id ( )
Link1 ( )
Link2 ( )

}

In the above representation, “EdgeInfo” occupies the first byte of each encoded version and provides information related to the corresponding edge. “EdgeInfo” includes two unused bits, a “WriteOp” bit that specifies if the edge is written to the graph database, a “Deleted” bit that specifies if the corresponding edge is deleted from the graph database, an “IdDeltaCompressed” bit specifying if the edge ID is delta encoded, and three “IdVBESize” bits specifying the number of bytes occupied by the encoded edge ID. The representation also includes a second byte containing “LinkInfo” that describes the linkages in the encoded version. The “LinkInfo” byte includes a “Link_1IsDeltaCompressed” bit that indicates if the first linkage in the encoded version is delta encoded, three “Link1VBESize” bits specifying the number of bytes occupied by the encoded first linkage, a “Link2IsDeltaCompressed” bit that indicates if the second linkage in the encoded version is delta encoded, and three “Link2VBESize” bits specifying the number of bytes occupied by the encoded second linkage. The first two bytes in the encoded version are then followed by a variable number of bytes containing the group varint and/or delta encoded versions of the edge ID (e.g., “ID”), first linkage (e.g., “Link1”), and second linkage (e.g., “Link2”)

As shown in FIG. 4, the first two bytes of encoded version 416 store the binary value of “00101000 100001000.” In the first byte, the first two bits are unused, the third bit is set to indicate that the corresponding record 404 is a write of an edge to the graph database, and the fourth bit is cleared to indicate that the record is not a deletion of the edge from the graph database. The fifth bit is set to indicate that the edge ID of the edge is delta encoded using the edge ID of the next record 406, and the sixth through eighth bits store “000” to indicate that the encoded value of the edge ID occupies one byte. In the second byte, the first bit is set to indicate delta encoding of the first linkage using the edge ID of record 404, the next three bits store “000” to indicate that the encoded value of the first linkage occupies one byte, the fifth bit is set to specify delta encoding of the second linkage using the edge ID of record 404, and the last three bits store “000” to indicate that the encoded value of the second linkage occupies one byte. As described above, the remaining three bytes of encoded version 416 respectively store the encoded values of the edge ID, first linkage, and second linkage for resolving the edge represented by record 404.

The first two bytes of encoded version 418 store the binary value of “00010001 10001000.” In the first byte, the first two bits are unused, the third bit is cleared to indicate that the corresponding record 406 is not a write of an edge to the graph database, and the fourth bit is set to indicate that the record is a deletion of the edge from the graph database. The fifth bit is cleared to specify that the edge ID of the edge is not delta encoded, and the sixth through eighth bits store “001” to indicate that the encoded value of the edge ID occupies two bytes. In the second byte, the first bit is set to specify delta encoding of the first linkage using the edge ID of record 406, the next three bits store “000” to indicate that the encoded value of the first linkage occupies one byte, the fifth bit is set to indicate delta encoding of the second linkage using the edge ID of record 406, and the last three bits store “000” to indicate that the encoded value of the second linkage occupies one byte. As described above, the remaining four bytes of encoded version 418 store the encoded values of the edge ID (in the first two bytes), first linkage (in the third byte), and second linkage (in the fourth byte) for resolving the edge represented by record 406.

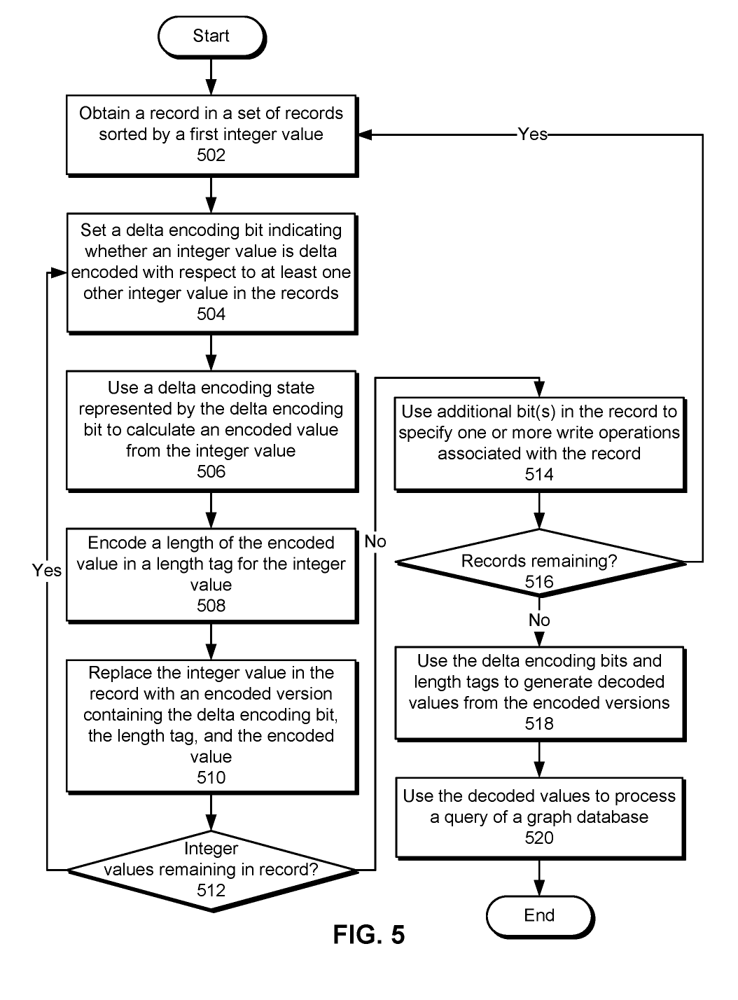

FIG. 5 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the technique.

Initially, a record in a set of records sorted by a first integer value is obtained (operation 502). The record may include one or more additional integer values that are smaller than the first integer value. For example, the record may specify one or more attributes of an edge in an edge store for a graph database. The first integer value in the record may represent an edge ID for the corresponding edge, and one or more additional integer values in the record may identify linkages used to resolve the edge. Because edges are written to the edge store in an append-only manner, the edge ID of a newer record may be strictly higher than the edge ID of an older record, while linkage values following the edge ID in a record may be smaller than the edge ID because the corresponding linkages are defined before the edge in the graph database.

Within the record, the first integer value and additional integer value(s) may be ordered in various ways. For example, the first integer value may always precede the additional integer value(s) in each record, or the first integer value may follow some or all additional integer values in some or all records.

Next, a memory footprint of the graph database may be reduced by encoding each integer value in the record. In particular, a delta encoding bit indicating whether the integer value is delta encoded with respect to at least one other integer value in the records is set (operation 504), and a delta encoding state represented by the delta encoding bit is used to calculate an encoded value from the integer value (operation 506). For example, the delta encoding bit may be set to indicate delta encoding of the integer value from another integer value and cleared to indicate a lack of delta encoding of the integer value. When the delta encoding bit is set for the first integer value in the record, the encoded value may be calculated from a difference between the first integer value and the first integer value in an adjacent (e.g., newer) record. When the delta encoding bit is set for an additional integer value in the record, the encoded value may be calculated from a difference between the additional integer value and the first integer value in the same record. When the delta encoding bit is not set, the encoded value may be calculated using a group varint and/or other variable-length integer encoding technique.

After the encoded value is calculated, a length of the encoded value is encoded in a length tag for the integer value (operation 508). For example, the length tag may include three bits that encode, from 1 to 8, the number of bytes occupied by a group varint encoded value representing a 64-bit memory address in a graph database. The integer value in the record is then replaced with an encoded version containing the delta encoding bit, the length tag, and the encoded value (operation 510).

Operations 504-510 may be repeated for remaining integer values in the record (operation 512). For example, the delta encoding bit, encoded value, and length tag may be generated for each unencoded integer value in the record and used as a replacement for the unencoded integer value to reduce the memory required to store the record. After all integer values in the record have been replaced with encoded versions, one or more additional bits in the record are used to specify one or more write operations associated with the record (operation 514). For example, the record may include an add bit that specifies writing or addition of the corresponding record to a database and/or other data store and/or a delete bit that specifies deletion of the corresponding record from the database and/or other data store.

After encoding of integer values is completed for a given record, remaining records (operation 516) in the set may be processed by obtaining each record (operation 502), encoding integer values in the record (operations 504-512), and using additional bits in the record to specify write operations associated with the record (operation 514). For example, all records in a given one-linkage or two-linkage structure of an edge store in a graph database may be compacted or compressed using operations 502-516. Moreover, encoded versions of records in the structure may be generated in descending order of the first integer value (e.g. edge ID) in the records to enable decoding of the records as the records are traversed in the same order to process deleted edges in the graph database.

Finally, the delta encoding bits and length tags are used to generate decoded values from the encoded versions (operation 518) of the records, and the decoded values are used to process a query of a graph database (operation 520). To produce each decoded value, the length tag may be used to identify the bytes containing the corresponding encoded value in a given record, and a group varint and/or other variable-length integer decoding may be used to obtain a decoded integer value from the encoded value. The decoded integer value and delta encoding state in the corresponding delta encoding bit may then be used to recover the original integer value when the delta encoding state indicates delta encoding of the original integer value. Finally, the decoded integer value may be included in a response to the query. For example, decoded integer values from one or more records may be used to resolve one or more edges stored in the graph database.

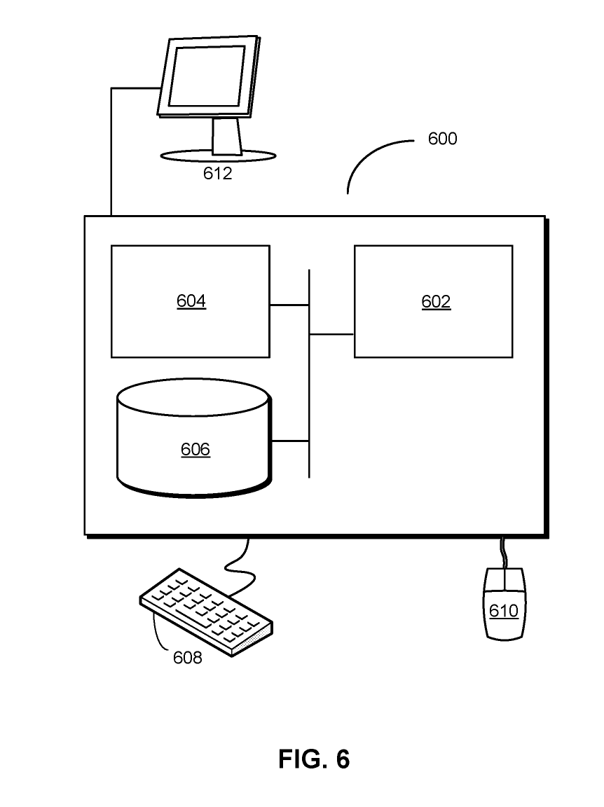

FIG. 6 shows a computer system 600 in accordance with an embodiment. Computer system 600 includes a processor 602, memory 604, storage 606, and/or other components found in electronic computing devices. Processor 602 may support parallel processing and/or multi-threaded operation with other processors in computer system 600. Computer system 600 may also include input/output (I/O) devices such as a keyboard 608, a mouse 610, and a display 612.

Computer system 600 may include functionality to execute various components of the present embodiments. In particular, computer system 600 may include an operating system (not shown) that coordinates the use of hardware and software resources on computer system 600, as well as one or more applications that perform specialized tasks for the user. To perform tasks for the user, applications may obtain the use of hardware resources on computer system 600 from the operating system, as well as interact with the user through a hardware and/or software framework provided by the operating system.

In one or more embodiments, computer system 600 provides a system for improving the memory footprint of a graph database. The system includes an encoding apparatus and a decoding apparatus, one or both of which may alternatively be termed or implemented as a module, mechanism, or other type of system component. The encoding apparatus may obtain a set of records sorted by a first integer value, with each record in the set of records containing the first integer value and one or more additional integer values that are smaller than the first integer value. For each record in the set of records and each integer value in each record, the encoding apparatus may set a delta encoding bit that indicates whether the integer value is delta encoded with respect to at least one other integer value in the set of records. Next, the encoding apparatus may use a delta encoding state represented by the delta encoding bit to calculate an encoded value from the integer value. The encoding apparatus may then encode a length of the encoded value in a length tag for the integer value and replace the integer value in the record with an encoded version containing the delta encoding bit, the length tag, and the encoded value.

The decoding apparatus may subsequently use the delta encoding bit and the length tag to generate a decoded value from the encoded value. The decoding apparatus may also use the decoded value to process a query of the graph database.

In addition, one or more components of computer system 600 may be remotely located and connected to the other components over a network. Portions of the present embodiments (e.g., encoding apparatus, decoding apparatus, graph database, etc.) may also be located on different nodes of a distributed system that implements the embodiments. For example, the present embodiments may be implemented using a cloud computing system that encodes and decodes edges in a remote graph database.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining, in a store maintained on a computer system, a set of records sorted by a first integer value, wherein each record in the set of records comprises the first integer value and one or more additional integer values; and
reducing an amount of memory used to store the records by performing, for each record in the set of records, the following operations on the computer system:
setting, for each integer value in the record, a delta encoding bit that indicates whether the integer value is delta encoded with respect to at least one other integer value in the set of records;
using a delta encoding state represented by the delta encoding bit to calculate an encoded value from the integer value;
encoding a length of the encoded value in a length tag for the integer value; and
replacing the integer value in the record with an encoded version comprising the delta encoding bit, the length tag, and the encoded value.

2. The method of claim 1, further comprising:
using one or more additional bits in the record to specify one or more write operations associated with the record.

3. The method of claim 2, wherein the one or more write operations comprise:
an addition; and
a deletion.

4. The method of claim 1, wherein using the delta encoding state represented by the delta encoding bit to calculate the encoded value from the integer value comprises:
when the delta encoding state indicates delta encoding of the first integer value, calculating the encoded value from a difference between the first integer value in the record and the first integer value in an adjacent record in the set of records.

5. The method of claim 1, wherein using the delta encoding state represented by the delta encoding bit to calculate the encoded value from the integer value comprises:
when the delta encoding state indicates delta encoding of an additional integer value that follows the first integer value in the record, calculating the encoded value from a difference between the additional integer value and the first integer value.

6. The method of claim 1, wherein the length tag comprises three bits representing a number of bytes in the encoded value.

7. The method of claim 1, wherein the encoded version is generated in descending order of the first integer value in the set of records.

8. The method of claim 1, further comprising:
using the delta encoding bit and the length tag to generate a decoded value from the encoded value; and
using the decoded value to process a query of a graph database.

9. The method of claim 8, wherein the decoded value is associated with at least one of:
a subject;
a predicate;
an object;
an offset; and
an edge.

10. The method of claim 8, wherein:
the first integer value comprises an identifier for an edge in the graph database; and
the one or more additional integer values comprise a linkage value for resolving the edge.

11. The method of claim 8, wherein the integer value comprises a first byte to an eighth byte of a 64-bit memory address in the graph database.

12. An apparatus, comprising:
one or more processors; and
memory storing instructions that, when executed by the one or more processors, cause the apparatus to:
obtain a set of records sorted by a first integer value, wherein each record in the set of records comprises the first integer value and one or more additional integer values; and
for each record in the set of records:
set, for each integer value in the record, a delta encoding bit that indicates whether the integer value is delta encoded with respect to at least one other integer value in the set of records;
use a delta encoding state represented by the delta encoding bit to calculate an encoded value from the integer value;
encode a length of the encoded value in a length tag for the integer value; and
replace the integer value in the record with an encoded version comprising the delta encoding bit, the length tag, and the encoded value.

13. The apparatus of claim 12, wherein the memory further stores instructions that, when executed by the one or more processors, cause the apparatus to:
use one or more additional bits in the record to specify one or more write operations associated with the record.

14. The apparatus of claim 12, wherein using the delta encoding state represented by the delta encoding bit to calculate the encoded value from the integer value comprises:
when the delta encoding state indicates delta encoding of the first integer value, calculating the encoded value from a difference between the first integer value in the record and the first integer value in an adjacent record in the set of records.

15. The apparatus of claim 14, wherein using the delta encoding state represented by the delta encoding bit to calculate the encoded value from the integer value further comprises:
when the delta encoding state indicates delta encoding of an additional integer value that follows the first integer value in the record, calculating the encoded value from a difference between the additional integer value and the first integer value.

16. The apparatus of claim 12, wherein the encoded version is generated in descending order of the first integer value in the set of records.

17. The apparatus of claim 12, wherein:
the first integer value comprises an identifier for an edge in the graph database; and
the one or more additional integer values comprise a linkage value for resolving the edge.

18. The apparatus of claim 17, wherein the linkage value is at least one of:
a subject;
a predicate; and
an object.

19. A system, comprising:
a graph database storing a graph, wherein the graph comprises a set of nodes, a set of edges between pairs of nodes in the set of nodes, and a set of predicates; and
an encoding module comprising a non-transitory computer-readable medium comprising instructions that, when executed, cause the system to:
obtain, for storage in the graph database, a set of records sorted by a first integer value, wherein each record in the set of records comprises the first integer value and one or more additional integer values; and
for each record in the set of records:
set, for each integer value in the record, a delta encoding bit that indicates whether the integer value is delta encoded with respect to at least one other integer value in the set of records;
use a delta encoding state represented by the delta encoding bit to calculate an encoded value from the integer value;
encode a length of the encoded value in a length tag for the integer value; and
replace the integer value in the record with an encoded version comprising the delta encoding bit, the length tag, and the encoded value.

20. The system of claim 19, further comprising:
a decoding module comprising a non-transitory computer-readable medium comprising instructions that, when executed, cause the system to:
use the delta encoding bit and the length tag to generate a decoded value from the encoded value; and
use the decoded value to process a query of the graph database.
